(19) United States
(12) Patent Application Publication
(10) Pub. No.: US 2024/0171040 A1
(43) Pub. Date: May 23, 2024

(54) ELECTRIC DRIVING FORCE DEVICE

(71) Applicant: Changzhou Taifei Electric Co., Ltd., Changzhou (CN)

(72) Inventors: Tianfeng Wu, Changzhou (CN); Dong Wu, Changzhou (CN)

(21) Appl. No.: 18/429,672

(22) Filed: Feb. 1, 2024

(51) Int. Cl. H02K 7/116; H02K 7/08

(52) U.S. Cl. CPC H02K 7/116; H02K 7/08

(57) ABSTRACT

The present disclosure belongs to the technical field of flight vehicle power devices, and particularly relates to a novel electric driving force device. More than two sets of driving motors are distributed in a solar planetary manner on a radial spatial plane with an output shaft as a center of gyration, to drive more than one set of reducing mechanism in parallel, so as to provide electric driving power for a flight vehicle.

### TECHNICAL FIELD

The present disclosure belongs to the technical field of flight vehicle power devices, and particularly relates to an electric driving force device.

### BACKGROUND

Driven by technological progress and pursuit of sustainable development, electrification of transport means has become an inevitable trend of development. For flight vehicles, the electrification of driving devices is a foundation and prerequisite for the electrification of the entire flight vehicle industry.

Currently, most flight vehicles are powered by internal combustion engines. In contrast, an electric propulsion system has advantages such as a simple structure, easy operation, low maintenance costs, high efficiency, and safety and reliability. Insufficient key performance of power devices is a technical challenge in development of various types of electric flight vehicles. In scenarios with high power requirements for active civil aircrafts and helicopters, a huge challenge in the design of electric flight vehicles lies in improving the energy efficiency, safety and reliability of power devices.

### SUMMARY

The present disclosure provides a novel electric driving force device, where more than two sets of driving motors are distributed in a solar planetary manner on a radial spatial plane with an output shaft as a center of gyration, to drive more than one set of reducing mechanism in parallel, so as to continuously output power and provide an electric driving force for a flight vehicle power assembly, so that an active flight vehicle rapidly evolves into an electric flight vehicle.

The electric driving force device includes: output shafts (100), where the output shaft refers to a gyration center shaft of the reducing mechanism for power output, or a gyration center output shaft of a set of the reducing mechanism, or a gyration center output shaft for a plurality of sets of reducing mechanisms connected in series;
central bearings (101), where the central bearings are a set of bearings installed in the middle of a box body, which support installation of driven wheels and output shafts, and mainly bear most of the load during operation of the electric driving force device;
driving motors (103), where the driving motors refer to permanent magnet synchronous driving motors in the form of radial-flux inner rotors, and are abbreviated as driving motors;
inverters (106), where the inverter is a current conversion device composed of an inverter bridge, a logic control circuit and a filter circuit, and is mainly configured for controlling driving motors;
a reducing mechanism (107), where the reducing mechanism consists of driving wheels (105) and driven wheels (104), playing a role in reducing a rotation speed of driving motors and increasing torque; and
one-way bearings (302), where the one-way bearing consists of an inner ring, an outer ring, a holder, and an irregular roller (an irregular needle roller), and refers to a clutch that transmits one-way rotational (forward or reverse rotation) power.

The beneficial effects of the present disclosure are as follows: 1. improving power redundancy and increasing safety and reliability; 2. reducing speed and increasing torque; 3. reducing maintenance costs; 4. and improving energy efficiency.

### BRIEF DESCRIPTION OF THE DRAWINGS

In order to more clearly illustrate the embodiments or technical solutions of the present invention, the accompanying drawings required for use in the embodiments or the technical solutions will be briefly introduced below.

FIG. 1 is a schematic diagram of energy transfer.

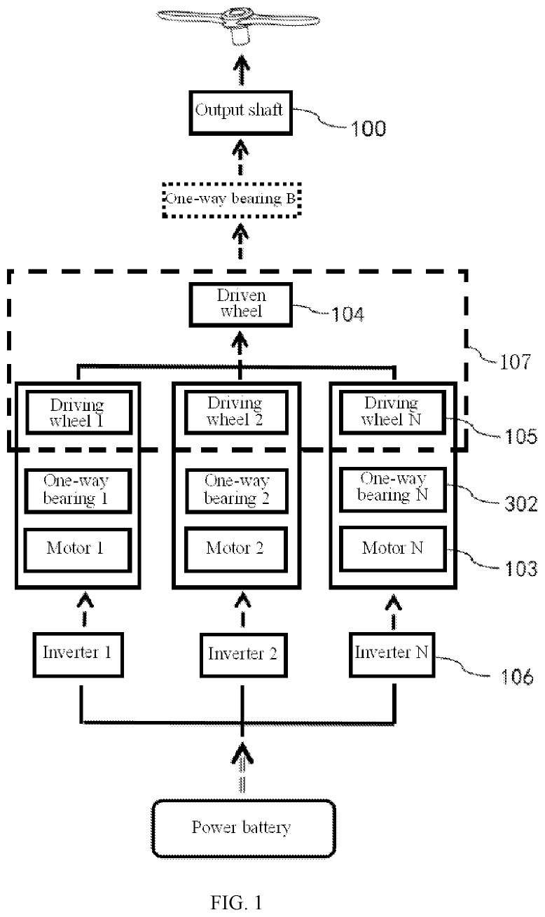

FIG. 2 is a form of parallel gear transmission.

FIG. 3 is a form of tangential screw roller transmission.

FIG. 4 is a form of parallel synchronous pulley transmission.

FIG. 5 is a form of concentric spiral bevel gear transmission.

FIG. 6 is a schematic diagram of a driving wheel with a one-way bearing structure.

### DETAILED DESCRIPTIONS OF THE EMBODIMENTS

The present disclosure provides a novel electric driving force device, and a core form of the device is as follows: more than two sets of driving motors are distributed in a planetary and parallel manner to drive more than one set of reducing mechanism to continuously output power. The device is designed to provide an electric driving force for a flight vehicle power assembly, which ensures continuous and minimum output of the electric driving force, and enables an active flight vehicle to rapidly evolve into an electric flight vehicle. The continuous output of the electric driving force refers to that in the process of implementing the present disclosure, selective operation or stop of each driving motor can be maintained according to an output instruction from an onboard computer of the flight vehicle, so as to maintain stability and continuity of required power output. The minimum output of the electric driving force refers to engineering measures taken by before engineering design of the present disclosure to avoid occurrence of any disastrous accident of the flight vehicle during cruising and meet the minimum lift requirements of the flight vehicle, that is, states of a set of driving motors in the present disclosure including a minimum rotation speed and a minimum torque of the same.

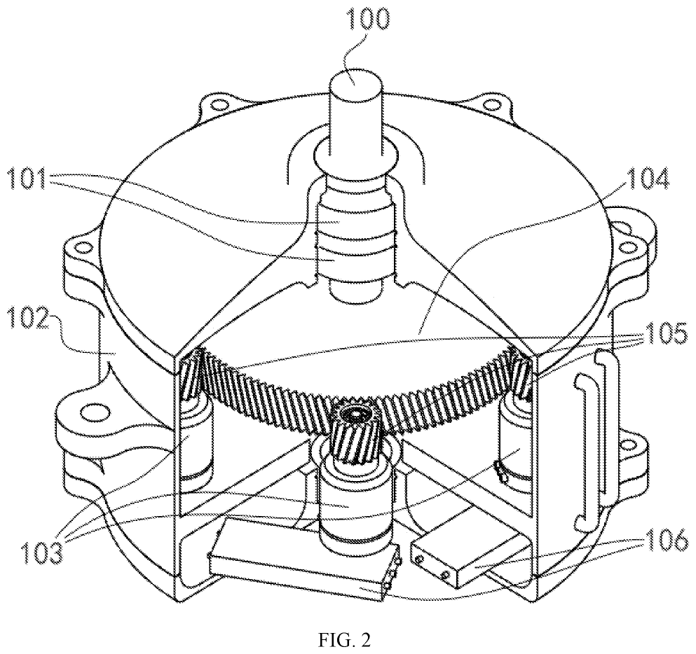

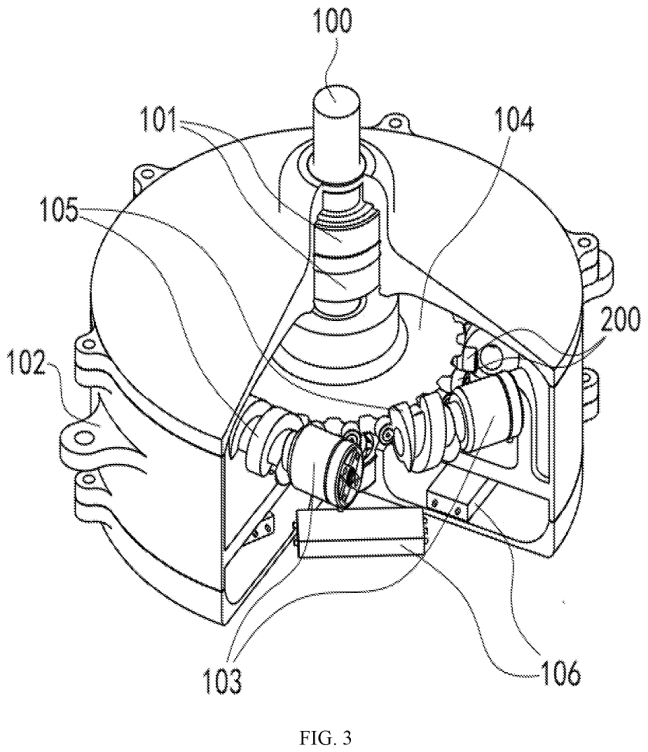

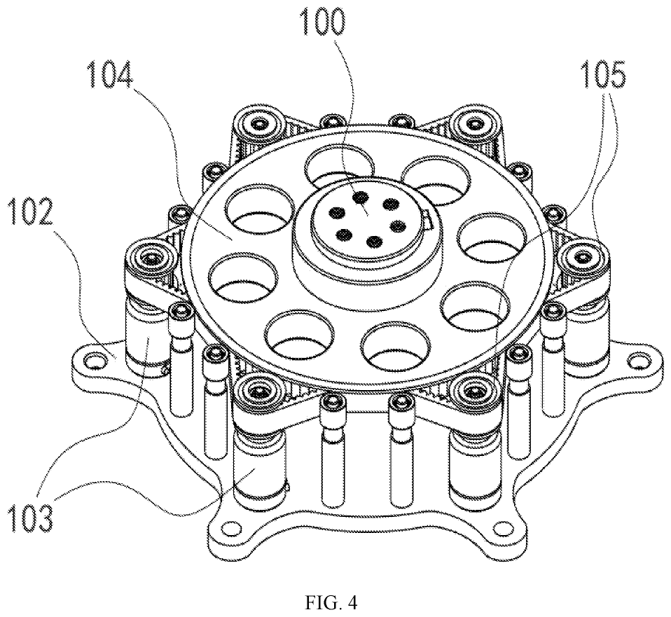

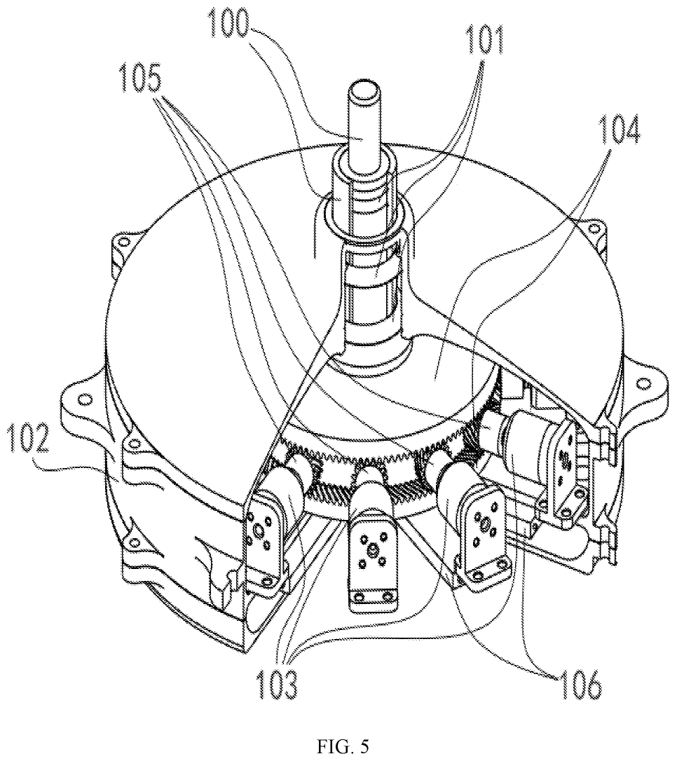

The present disclosure includes a box body, more than two sets of driving motors, more than one set of reducing mechanism and output shaft, where the more than sets of driving motors are distributed in a solar planetary manner with the output shaft as center (but it is not limited to this distribution manner, that is, the driving motors can also be distributed in a circumferential and even manner, a symmetrical manner or an irregular manner, but a specific distribution manner depends on actual scene requirements). According to different spatial states of gyration centerlines of a driving motor shaft and the output shaft, distribution manners of the driving motors include but are not limited to the following: 1. the gyration centerlines of the driving motor shaft and the output shaft are spatially parallel to each other (as shown in FIGS. 2 and 4); 2. the gyration centerlines of the driving motor shaft and the output shaft are spatially concentric with each other (as shown in FIG. 5); and 3. the gyration centerlines of the driving motor shaft and the output shaft are spatially tangent to each other (as shown in FIG. 3).

Types of transmission structures adopted for the reducing mechanism are different, including but not limited to the following:
1. synchronous pulley transmission (as shown in FIG. 4);
2. gear transmission (as shown in FIGS. 2 and 5); and
3. screw roller transmission, etc. (as shown in FIG. 3).

Studies on electric vehicles show that in order to achieve the same power performance under the condition of absence of a reducing mechanism, a higher-power driving motor and a larger-capacity power battery are required to achieve the target performance, but it not only increases a weight and volume, but also reduces range and economy. In the present disclosure, the reducing mechanism is installed between the driving motor and the output shaft, which not only avoids the above defects, but also optimizes the power output, protects the driving motors, and reduces maintenance costs.

In the present disclosure, corresponding driving motors are controlled through more than two sets of inverters, the reducing mechanism is driven in parallel, and the electric driving power is provided for the flight vehicle through the output shaft. The so-called parallel driving refers to that a single driving motor is capable to drive the entire reducing mechanism to operate, and in the operation process, when any individual driving motor or inverter malfunctions, it will not have a significant impact on normal operation of a driving device of the present disclosure. Effect of the parallel driving is achieved mainly due to installation of a one-way bearing between a driving wheel and a driven wheel, as well as planetary distribution of a plurality of driving motors. In addition, when components of various mechanisms are manufactured or when the driving motors are in operation, there exist corresponding differences (such as manufacturing tolerances, assembly tolerances, usage environment differences, electrical signal transmission differences, etc.). By installing the one-way bearing between the driving motor and the driving wheel, smooth and continuous power output can be guaranteed.

Taking gear transmission with a relatively simple transmission structure as an example, a detailed explanation is made below:

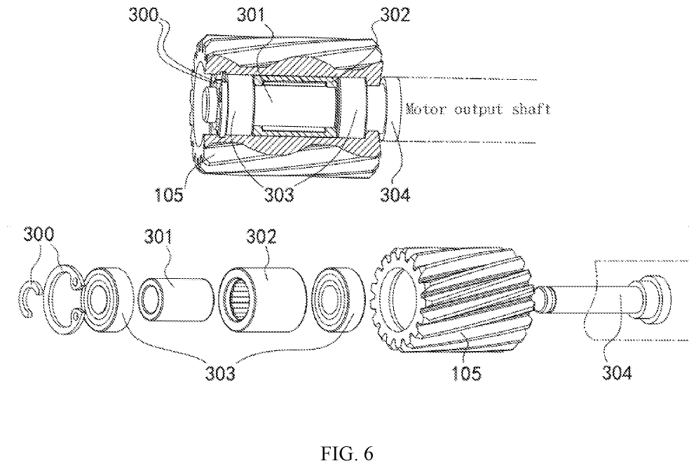

As shown in FIGS. 2 and 6, an electric driving device of gear transmission includes: output shafts (100), central bearings (101), a box body (102), driving motors (103), a reducing mechanism (107) composed of driven wheels (104) and driving wheels (105), inverters (106), one-way bearings (302), a built-in steel sleeve (301), bearings (303), some standard mechanical fasteners (such as fasteners 300 in FIG. 6) and other parts.

The box body (102) is made of aluminum alloy and is mainly configured for installing various necessary parts, playing a role in protection, sealing, heat dissipation, installation and fixation, etc.

The central bearings (101) are a set of bearings installed in the middle of the box body (102), which support the installation of the driven wheels (104) and the output shaft (100).

The output shaft (100) and the driven wheels (104) can be connected together, and a rotating rod made of alloy steel and configured for outputting power can be designed to rotate forward or reversely according to actual needs.

The driving motors (103) are installed inside the box body (102), driving motors of aviation-certified models are generally adopted, a single driving motor and a single inverter constitute a driving unit, and the inverters (106) control forward or reverse rotation according to actual needs.

The driven wheels (104) are connected to the output shaft (100) and rotate under the driving action of the driving wheels (105).

The driving wheels (105) are distributed around the driven wheels (104) in a planetary manner, correspondingly configured together with the driving motors (103), and transmitted in a form of gear mesh. The transmission structure between the driving wheel (105) and the driven wheel (104) is referred to as the reducing mechanism (107), and a reduction ratio between the driving wheel (105) and the driven wheel (104) is determined according to actual needs.

The inverters (106) are connected to the driving motors (103), and each inverter (106) controls a corresponding driving motor (103) to receive start, stop and brake signals and control the start, running speed, stop and braking of the driving motors.

The one-way bearing (302) is installed inside the driving wheel (105), where an inner hole surface of the built-in steel sleeve (301) of the one-way bearing (302) is fastened and connected to an outer ring surface of the output shaft (100) of the driving motor, and an outer ring surface of the one-way bearing (302) is fastened and connected to an inner hole surface of the driving wheel (105). The main functions of a power transmission mechanism include: 1. unidirectional transmission of power; 2. overrun clutching; 3. separation of the power assembly.

The bearings (303) are symmetrically installed on both sides of the one-way bearing (302).

Various standard mechanical fasteners (such as fasteners 300 in FIG. 6) mainly include bolts, nuts, snap springs, keys, sealing rings, and oil, which are used for assembly, fixation, sealing, cooling and lubrication of various components and parts.

Take a helicopter using the present disclosure as a power device for further illustration. Before takeoff of the helicopter, under the condition of ensuring that all equipment are in normal working conditions, a flight control system of the helicopter transmits signals to control all inverters (106), the power battery, under the control of each inverter (106), outputs the required electric energy to a corresponding driving motor (103), each inverter (106) drives a corresponding driving motor (103) to rotate by controlling a certain current value, and in this case, a locked state of the one-way bearing (302) is formed when the driving motor (103) rotates and outputs power, and each driving motor (103) generates similar power to drive a corresponding driving wheel (105) to rotate in the same direction and rotation speed [corresponding differences exist in manufacturing and operation of each driving motor (103) and each inverter (106), and even in case of distribution in a circumferential and even manner, the power generated by each set of power unit cannot be guaranteed to be exactly the same, that is, driving forces generated by the driving wheels (105) are unevenly distributed, but are only similar]. Each driving wheel (105) rotates to generate a driving force to drive the corresponding driven wheel (104) to rotate, and finally, the power generated by all driving motors is outputted in a concentrated manner through the output shaft (100) driven by the driven wheels. When the inverters (106) increase the current to accelerate the rotation of the driving motors (103), and the output power makes a lift force generated by rotor wings sufficient to overcome gravity of the helicopter, the helicopter will take off.

In a cruising process of the helicopter, when it is needed to reduce power output, the power generated by the power device can be reduced by controlling the rotation speeds of all driving motors (103), or by reducing the rotation speeds of several driving motors or putting the several driving motors in a standby mode to stop rotating (the specific number of controlled driving motors is a relative number that needs to be calculated repeatedly according to actual conditions, which will not be explained in detail here). When an output speed [a linear speed on the outer ring surface of the built-in steel sleeve (301) of the one-way bearing (302)] is lower than an idle speed [a linear speed on an inner surface of the outer ring of the one-way bearing (302)], the one-way bearing (302) is in a separated state, the driving wheels (105) are driven by the driven wheels to be idle, and the driving motors are in a stopped state (when some driving motors or inverters fail to operate normally, a corresponding one-way bearing is also in a separated state). On the contrary, when it is needed to increase the power output, the rotation speeds of all driving motors (103) can be increased, or the rotation speeds of previously slowed down or stopped driving motors can be accelerated, and when a linear speed of output is greater than an idle linear speed, the one-way bearing (302) enters a torque locking state again from the separated state, so as to drive the driving wheel to rotate and output power.

When the helicopter needs to land, the power device is used to decelerate and move the helicopter to a destination, and the principle and method of controlling the power level are similar to those in the above steps.

Like all other energy conversion devices, an energy conversion device of the present disclosure has varying energy conversion efficiency, specifically depending on the types, quantity and spatial arrangement structures of the driving motors adopted, and also adopted transmission modes of the reducing mechanism. The driving motors of the present disclosure are permanent magnet driving motors, which are likely to demagnetize at high temperatures, so that a heat dissipation device is required in most application scenarios. Therefore, in the present disclosure, a non-conductive and non-magnetic oil-cooled heat dissipation method can be adopted.

In certain situations where power output in a contra-rotating direction is required (such as coaxial contra-rotating fans and coaxial contra-rotating twin rotors of the helicopter), the present disclosure can also adopt an appropriate form to meet the requirements of contra-rotating output power. As shown in FIG. 5, more than two sets of driving motors (106) and driving wheels (105) drive in parallel two driven wheels (104), so that two output shafts (100) can rotate in an opposite direction. This figure shows only a formal structure with a plurality of output shafts in an embodiment, and other details will not be enumerated here.

In some cases, driving motors of different volumes and powers are combined with adaptive driving wheels to drive the same driven wheel separately. For example, a gear transmission form in which more than two sets of 10 kW driving motors drive 7 gears is combined with another gear transmission form in which more than two sets of 4 kW driving motors drive 13 gears, and high performance and efficiency are generated in multiple scenarios, just as the processor chips of smartphones can be divided into large-core and small core architectures.

In some cases, when a forward flight speed of a helicopter provided with a forward thrust device (such as a S-97 helicopter of Sikorsky) in a high-speed flight state reaches a certain value, forward flight airflow can push a main rotor to generate a sufficient lift force, so that the driving motors do not need to provide power to the main rotor, and the helicopter can fly forward at high speed under the driving action of the forward thrust device. However, the prerequisite for achieving flight of a rotary-wing aircraft is to install a one-way clutch between a driving shaft and an electric driving device below the main rotor. Similarly, a one-way bearing can also be installed between the output shaft and the driven wheel of this device, so that the flight speed and range can be improved.

The present disclosure is a conceptual technical discussion device for solving electrification concept problems of active flight vehicles. Before specific project implementation, specific application scenarios need to be determined, and without this premise, specific design work cannot be carried out. Like an application of most conceptual technologies in the industry, the application of this technology to the field of flight vehicles requires sufficient feasibility experiments and engineering practice trials. The present disclosure only elaborates on structural features and cannot be applied in specific scenarios, and a specific application scenario need to be designed according to many factors such as the spatial size and power requirements of an actual scenario.

Safety is the top priority for a flight vehicle as a means of transportation. On the basis of ensuring safety, various functional and overall performance requirements can be raised. Large driving motors are expensive to design and manufacture, and difficult to maintain, thus generating high maintenance costs. During operation of the large driving motors, it is relatively difficult to start and brake, thus resulting in high energy consumption. When large driving motors of a flight vehicle as a power device malfunction, consequences generated therefrom will be disastrous. The present disclosure has the following characteristics: standardized, modular and low-cost production of power units can be achieved, all driving devices are arranged in a centralized manner, power output is centralized, cooling and protection devices are simple, installation and maintenance are easy, and power redundancy is sufficient, so that larger space can be provided for design of a flight vehicle.

The present disclosure is not only used as an electric driving force device of a flight vehicle, but also can be combined in series with other reducing mechanism, which can be applied in other usage scenarios, such as electric modification of engineering machinery, ships, etc.

The above are merely preferred embodiments of the present invention, and are not intended to limit the present invention. Any modifications, equivalent replacements and improvements made within the spirit and principle of the present invention should fall within the protection scope of the present invention.

What is claimed is:

1. A novel electric driving force device, comprising a box body (fixed box body), driving motors and inverters, a reducing mechanism composed of driving wheels and driven wheels, central bearings, output shafts (output ends), some standard mechanical fasteners and other parts, wherein more than two sets of driving motors are distributed in a solar planetary manner on a radial spatial plane with an output shaft as a center of gyration, to drive more than one set of reducing mechanism in parallel.

2. The novel electric driving force device according to claim 1, wherein a one-way bearing is installed between an output shaft and a driving wheel of a driving motor.

3. The novel electric driving force device according to claim 1, wherein a one-way bearing can also be installed between an output shaft and a driven wheel.
